(19) United States
(12) Patent Application Publication
(10) Pub. No.: US 2005/0140059 A1
(43) Pub. Date: Jun. 30, 2005

(54) Method and device for producing nonwoven moulded bodies

(75) Inventors: Michael Ernst, Bocholt (DE); Holger Sieben, Bocholt (DE); Klaus Menke, Bocholt (DE)

Correspondence Address: Friedrich Kueffner, Suite 910, 317 Madison Avenue, New York, NY, 10017, US

(73) Assignee: Johann Borgers GmbH & Co. KG, Bocholt (DE)

(21) Appl. No.: 10/504,627

(22) PCT Filed: Feb. 15, 2003
(86) PCT No.: PCT/EP03/01542

(30) Foreign Application Priority Data
Feb. 27, 2002 (DE) 102 08 524.2

(51) Int. Cl. B29C 31/00; B29C 43/10

(52) U.S. Cl. 264/322; 264/324; 264/510; 264/571; 425/388

(57) ABSTRACT

During the production of moulded bodies from a nonwoven (20) which can be solidified by a binding agent (11), differences in contour arise in critical profile regions of the moulded body using known methods. This especially occurs where the profile (26) has sharp curves or where the height of the profile sharply increases. According to the invention, moulded bodies having accurate profiles are produced by subjecting the nonwoven (20) to a suction process in points, i.e. at least in the critical profile regions, in the step of the method during which die form tool is closed. The air enclosed inside die nonwoven is thereby sucked out (37) and is used to position the fibre bundles on the contour of the form tool (25, 26) in an accurate manner. This enables an accurate embodiment of the moulded body to be obtained in terms of its contour, during cooling and hardening.

The invention concerns first a method for producing molded parts from a nonwoven that can be bonded by bonding agents, which is carried out basically in the manner specified in the introductory clause of claim 1. The structure and bonding of these nonwovens are described in DIN 61210. Nonwovens of this type consist, on the one hand, of fibrous material and, on the other hand, of bonding agents for the fibers.

The fibers can be organic in nature, can be natural-synthetic, or can have an inorganic base. Examples include reprocessed cotton, flax, jute, polyester fibers, acrylic fibers, rock wool, or glass fiber.

The bonding agents are generally synthetic in nature. Materials that can be used for this purpose are thermoplastics and thermosetting plastics, such as polypropylene, polyester and phenolic resin, and epoxy resins. These agents can be applied in powdered form from solutions or dispersions. It is especially advantageous to use the bonding agents in the form of fibers, which we shall refer to as “bonding fibers” for short.

The nonwovens are mechanically produced by carding with web lamination or by aerodynamic means. The final product, namely, the bonded molded part, is produced by compression molding in a press that consists of a male mold and a female mold. If thermoplastic bonding agents are used, the sequence of treatment is hot-cold, whereas a cold-hot treatment sequence is used if thermosetting materials are used as the bonding agents. To improve the handling of the nonwoven during insertion in the molds, it is advisable to prebond the nonwoven mechanically and/or thermally. This can be accomplished, for example, by heating until the bonding agents in the nonwoven soften. The bonding agents in the nonwoven then produce slight interconnection of the fibers. The production process can be made especially cost-effective by combining the formation of the nonwoven and the compression molding in one operation. In this case, the nonwovens that have been treated with bonding agents are immediately placed in molds, in which they are compressed into molded parts.

Depending on the composition and production of the nonwovens, closed or open molded parts are used. This depends on whether the molded parts to be produced must be cooled or heated during compression. The transfer of the heat for treating the nonwoven can occur through the material of the molds or through the fluid air or through high-pressure steam.

The density of the molded parts falls in the range of 100 to 1,000 kg/cubic meter. The density is not always uniform and can vary within a molded part. An important use of molded parts of this type is in automobile construction, specifically, as fittings on the inside or outside of automobile bodies. They are used for acoustic insulation or sound absorption. In some cases, they can also act as support structures. Examples include floor insulation under the carpet, dashboard insulation or engine hood insulation, side paneling in the vehicle, or the headliner.

Molded parts of this type have been effectively used for decades, but they have the significant disadvantage that their conformability during compression molding is inadequate. There are critical mold regions in the molds, where the inner contour of the mold cavity has a strong curvature or where its profile height sharply increases. In previously known methods, exact shape adaptation to the desired inner contour of the mold is not possible.

Previous attempts to eliminate the disadvantage of lack of conformability have been unsuccessful. One such attempt consisted in increasing the thickness of the nonwovens. Another attempt consisted in using additional layers of nonwovens in the critical areas. However, the desired conformability could not be achieved in this way, and other significant disadvantages appeared. One of these disadvantages is the higher cost of producing these molded parts and the unwanted weight increase of the molded parts associated with this method. This is unacceptable for the use of these molded parts in the automotive sector.

The Japanese document JP 4[1992]-332,591 describes a method in which an air-permeable pad is covered with a surface material. This is carried out in a device that consists of two molds, in which the lower mold has air channels to which a vacuum is applied, while the upper mold has air channels through which hot air is delivered to the molded part. However, in this method, the molded part is already preshaped, so that it already has the desired geometry.

The Japanese document JP 6[1994]-322,651 describes a method for molding nonwoven molded parts. In this method, the raw material is covered with an air-impermeable layer and is then given the desired shape in a mold that has vacuum channels, which are arranged in the critical areas. The disadvantage of this deep-drawing method is that only molded parts with approximately the same wall thickness can be produced.

The document U.S. Pat. No. 2,459,804 describes a device for producing felt hats and similar objects. In a first arrangement, the raw material is uniformly laid down on a male mold that contains vacuum channels. A vacuum is applied to the vacuum channels for this purpose. In a second step, this male mold with the raw material is brought together with a corresponding female mold. The material located between the two molds is pressed into the desired shape under the action of heat. However, in this method, a vacuum is not applied to the vacuum channels of the male mold. Another embodiment also has a mold that consists of a male mold and a female mold, in which the felt material is arranged between these two parts of the mold. Both molds have air channels. The male mold is filled with high-pressure steam, which penetrates the female mold through the air channels of the male mold, through the molded part and then through the air channels of the female mold. This high-pressure steam serves to shape the molded part. This device likewise cannot provide exact shape adaptation in the critical mold areas.

These disadvantages are eliminated by the method specified in claim 1. In this method, in the step specified in the characterizing clause of claim 1, in which the mold is closed, pointwise regional suction is applied to the preliminary product present in the mold, at least in the aforesaid critical profile regions. This sucks out the air trapped inside the nonwoven. During this suction process, a stream of air can move the nonwoven that has been treated with bonding agents from the interior of the mold towards the contour of the mold. The pressed fibers remain in their conformal position until the integrated bonding agents have cooled and hardened. When the finished molded part is removed from the mold, it has the desired, exactly adapted profile even in the critical regions.

One possibility for producing the molded parts in a so-called “thermoplastic technique” is specified in method claim 3. A second possibility, which characterizes the so-called “thermosetting technique”, is specified in method claim 9.

The invention is also aimed at a device for carrying out a method of this type. The special measures of the device of the invention are described in claim 11. The special feature consists in the assignment of a suction device to the mold. One or more suction lines lead from the suction device and are connected at well-defined points of the mold. Suction channels lead from the connection points of these suction lines, penetrate the wall of the mold, and open on the inner contour of the cavity.

Other measures and advantages of the invention are specified in the dependent claims and the following description and are shown in the drawings. The drawings illustrate a specific embodiment of the invention.

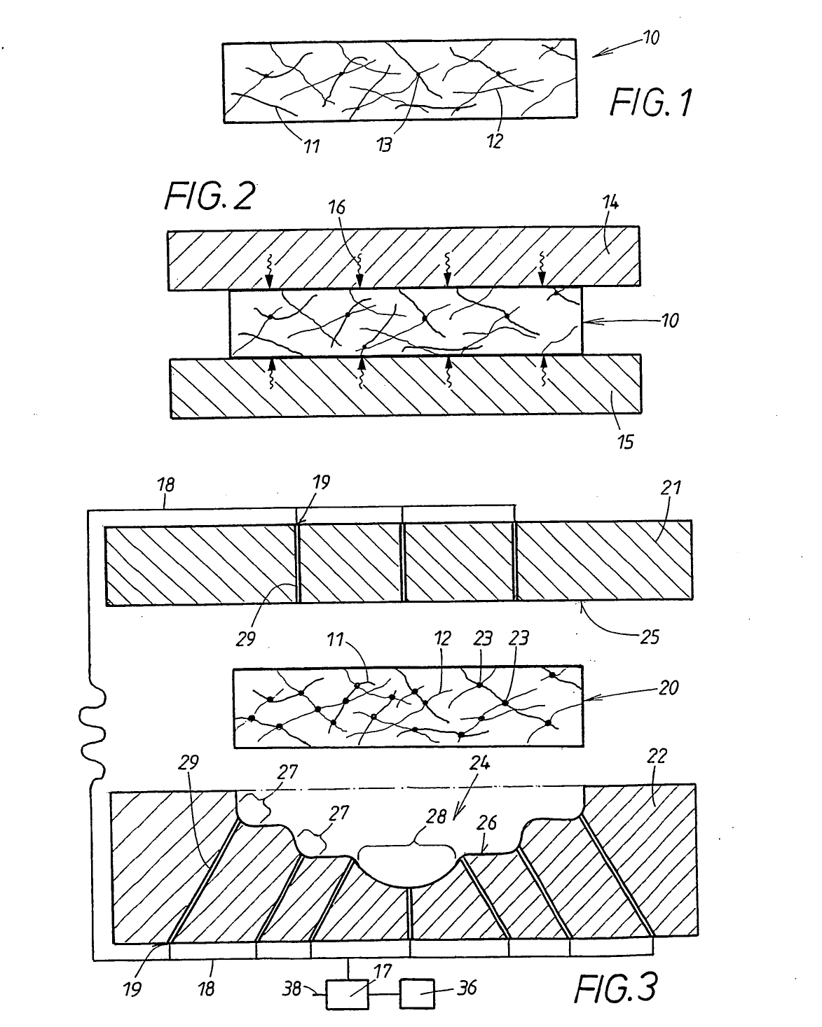

FIG. 1 shows a schematic cross section of a preliminary product produced from the nonwoven, which consists of a prebonded nonwoven that has been treated with bonding agents.

FIG. 2 illustrates a first step of the method, in which the preliminary product is subjected to heating until the bonding agents soften.

FIG. 3 shows the next step of the method, in which the preliminary product heated as illustrated in FIG. 2 is placed in a two-part mold, in which it is treated in a special way that will be described in detail below.

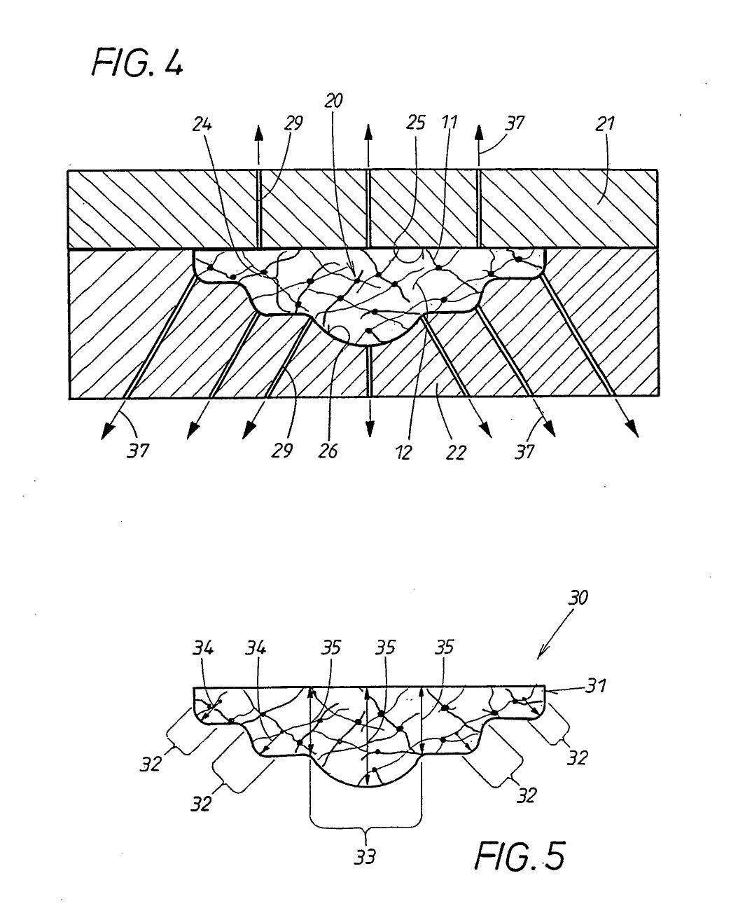

FIG. 4 shows this special treatment, which occurs in a step of the method with the mold closed.

FIG. 5 shows the molded part produced by the method of the invention.

FIG. 1 shows a schematic cross section of a preliminary product 10, which will be used to explain the method of the invention in greater detail with reference to the drawings. This preliminary product 10 is a nonwoven produced by aerodynamic means. The nonwoven is a homogeneous mixture of, for example, four components. A first component, which is identified by reference number 11 in FIG. 1, is a so-called bicomponent fiber, which has a covering consisting of thermoplastic material around a central fiber core. This component is the “bonding agent” in the nonwoven, namely, in the form of the “bonding fiber” mentioned earlier. Other components, which are shown in FIG. 1 in fiber form and are identified by reference number 12, can be of various types. Instead of fibers, a portion of the mixture components can also consist of foam flocks. A mixture of reprocessed cotton, polypropylene fibers, and possibly polyurethane foam flocks has been found to be effective. The mixing ratio of these bonding agents 11 and the three other components mentioned above can be 15:45:15:25 wt. % in the order specified above.

To allow better handling of the nonwovens, the fiber elements 11, 12 should already adhere to one another somewhat. This is best accomplished by slight heating of the nonwoven, which results in the formation of adhesion points 13 between the fibers 11, 12. The preliminary product 10 is formed in this way. This type of prebonding of the nonwoven can also be produced mechanically instead of thermally.

As FIG. 2 shows, this preliminary product 10 is placed between two heating plates 14, 15, where the bonding fibers 11 soften to the desired extent. The penetration of the heat for heating and softening the bonding fibers 11 is illustrated in FIG. 2 by the wavy arrows 16. With the aforementioned composition of the preliminary product 10, the heating plates 14, 15 produce a temperature of, e.g., 200° C. for one minute. During this treatment in FIG. 2, the bonding agents develop their effect to the desired extent and lead to an intermediate state 20 of the preliminary product, which is shown in FIG. 3. In this intermediate state, the bonding agents 11 have become fully active and have produced a strong bond 23 between the fibers 11, 12. When the nonwoven has been converted to this intermediate state 20, it is immediately sent to the compression molding step. This compression molding is carried out in a two-part mold, which is shown in FIG. 4 and has the special design shown in FIG. 3.

The mold consists of a male member 21 and a female member 22, which, in the closed state shown in FIG. 4, enclose a cavity 24 between them, which is the negative of the desired profile of the finished molded part 30. The appearance of this molded part is shown, for example, in FIG. 5. As was described earlier, a finished product 30 of this type can have critical profile regions, which are labeled 32 and 33 in FIG. 5. The profile regions 32 consist of regions where the contour profile 31 of the molded part 30 shows strong curvature, which is symbolically illustrated in FIG. 5 by a radius of curvature 34. Other critical profile regions 33 occur in places where there is a sharp increase in the profile height, which is labeled 35. The problems are best illustrated by the negative profile of the two mold members 21, 22 indicated in FIG. 3.

In the present case, one of the mold members 21 has a relatively simple, e.g., flat, inner contour 25, but the other mold member 22 has a complicated relief with a jagged inner contour 26. If, as illustrated in FIG. 3, the preliminary product 10 in intermediate state 20 is placed in the cavity 24 and then cooled with the mold 21, 22 closed, it would not be expected in the state of the art that the nonwoven would enter the contour regions 27, 28 of the mold. Instead of the nonwoven conforming to the inner contour 26, the critical contour regions 27, 28 would not be filled by the intermediate product 20. If the intermediate product 20 is then cooled between the cool molds 21, 22, the finished molded part would have profile deviations in the aforementioned critical profile regions 32, 33. The molded part 30 would not have the desired quality.

However, the method in accordance with the invention achieves this by means of the special press shown in FIG. 3. As is illustrated schematically in FIG. 3, a suction device 17 is assigned to the mold members 21, 22, and a multiplicity of suction lines 18 leads out from the suction device. The suction lines 18 are connected at well-defined points 19 of the two mold members 21, 22, at which at least one suction channel 29 originates. These suction channels 29 open in all of the critical contour regions 27, 28 of the inner contour 26, but it is also advantageous to run them as far as the inner contour 25 of the opposing mold member 21. The suction channels 29 pass through the wall of the mold members 21, 22. It is sufficient to provide the suction channels 29 only at certain points in these contour regions 27, 28. A diameter of the suction channels 29 of about 1 millimeter is sufficient.

As FIG. 3 also shows, the suction device 17 can have a control unit 36, which predetermines the time of initiation and the duration of the suction action of the device 17 and determines them as a function of the progress of the formation of the molded part in the cavity 24. The resulting effects are shown in FIG. 4. The suction device 17 has an air outlet 38.

As has already been mentioned, the preliminary product 10 in the hot intermediate state 20 is placed in the cavity 24 between the two mold members 21, 22, which are then closed. The cavity is then sealed media-tight. The suction device 17 described above is activated immediately after the mold members 21, 22 have been closed. It applies suction to the enclosed nonwoven, which is still in the hot intermediate state 20, as is illustrated in FIG. 4 by suction arrows 37 at each of the suction channels 29. During this suction 37, airflow occurs inside the hot nonwoven intermediate product 20, which causes the large numbers of fibers 11, 12 to be carried along and moved toward the contours 25, 26. This occurs above all in the critical contour regions 27, 28 illustrated in FIG. 3. The ultimate result of this movement of fibers in the mold cavity 24 is a conformal position of the fibers 11, 12 in the two mold members 21, 22. When the suction 37 is applied, as shown in FIG. 4, the hot air inside the nonwoven is removed. This removal of the hot air leads to more rapid, intense cooling of the intermediate product, which results in rapid bonding of the nonwoven.

The result of this process is apparent from the cross section of the finished product 30 in FIG. 5. Due to the suction treatment at 37 in FIG. 4, a conformal course of the contour profile 31 is obtained, even in the critical profile regions 32, 33. A molded part 30 of the highest quality is obtained.

In many applications of the device of the invention, it is sufficient to apply the suction effects 37 only in the area of one of the mold members, i.e., member 22, namely, where the critical profile regions 32, 33 are located. However, as FIG. 3 shows, suction channels 29 are provided in both mold members 21, 22 in the present case.

The nonwoven does not have to be realized as a preliminary product 10 with prebonded adhesion points 13, but rather it could be directly subjected to the heat treatment between the heating plates 14, 15 or, alternatively, it could be subjected to the heat treatment in heated mold members 21, 22. Instead of the aforementioned nonwoven, an alternative nonwoven could be formed in three layers and could consist, for example, of a bicomponent fiber, reprocessed cotton, and polypropylene in a ratio of 20:60:20 wt. %. In this connection, the nonwovens can have a weight of 200-600 g per square meter.

The nonwovens can be covered on both sides or on one side with moldable decorative layers or layers of plastic, which are also carried along during the suction treatment to conform to the inner contours of the mold. If possible, these cover layers should be permeable to the suction air.

The aforementioned suction treatment 37 in the invention occurs as soon as the two mold members 21, 22 are closed. A short surge of suction is sufficient here. Instead of one surge of suction, several surges of suction could be applied in succession, whose duration and suction maximum are adapted to the individual structure of the nonwoven.

### List of Reference Numbers

10 preliminary product
11 bonding agent, bicomponent fibers
12 organic or mineral fibers of 10
13 adhesion points between 11, 12
14 first heating plate (FIG. 2)
15 second heating plate (FIG. 2).
16 arrow showing flow of heating and softening heat from 14, 15 to 10 (FIG. 2)
17 suction device (FIG. 3)
18 suction lines of 17 (FIG. 3)
19 points of connection of 18 at 21, 22 (FIG. 3)
20 hot intermediate state of 10 (FIG. 3)
21 first mold member, male mold
22 second mold member, female mold
23 bonding points between 11, 12, bonds (FIG. 3)
24 cavity between 21, 22
25 inner contour of 21 (FIG. 3)
26 inner contour of 22 (FIG. 3)
27 critical contour region on 26 (FIG. 3)
28 critical contour region on 26 (FIG. 3)
29 suction channel in 21, 22 (FIG. 3)
30 finished molded part, finished product (FIG. 5)
31 contour profile of 30 (FIG. 5)
32 critical profile regions of 30, strong curvature of 31
33 critical profile region of 30, sharp increase in height of 31
34 radius of curvature of 31 at 32
35 profile height at 33
36 control unit
37 arrow of air suction
38 air outlet at 17 (FIG. 3)

1. Method for producing molded parts (30) from a nonwoven (10, 20) that can be bonded by bonding agents (11) and by pressing,
in which first the nonwoven, which is provided with preferably thermoplastic bonding agents (11), is produced and thermally and/or mechanically prebonded to form a preliminary product (10) to allow it to be easily handled thereafter,
then the preliminary product (10) is subjected to heating (16) until plastification of the bonding agents (11) occurs, inserted in a compression molding mold (21, 22), which consists of at least two mold members, which, when the compression mold is closed, form a cavity that represents the negative of the desired molded part, and compressed in the compression molding mold,
whereupon the bonded molded part (30) with the desired profile (31) is formed by cooling and/or hardening of the intermediately plastic bonding agents (11) between the fibers (12) in the preliminary product (10, 20),
where the molded part (30) has critical profile regions (32, 33) with strong curvature (34) of its contour and/or a sharply increasing profile height (35), wherein, in the step of the method in which the mold (21, 22) is closed, pointwise suction (37) is applied, at least in the critical profile regions (32, 33), to the preliminary product (10, 20) enclosed in the mold (21, 22), which causes the air enclosed in the interior of the nonwoven to be drawn off by suction (37).

2. Method in accordance with claim 1, wherein the nonwoven that has been treated with the bonding agents (11) is moved from the interior of the mold towards the contour (26, 25) of the mold (21, 22) by the airflow that develops during the suction (37) and remains in this conformal position until the integrated bonding agents (11) have cooled and hardened.

3. Method in accordance with claim 1, wherein the preliminary product (10) is first heated to the requisite operating temperature outside the mold (21, 22), and that the preliminary product, which is in the hot intermediate state (20), is then placed in the mold (21, 22), which itself is cool, and the mold (21, 22) is closed.

4. Method in accordance with claim 3, wherein the preliminary product (10) is heated to the requisite operating temperature (20) between two heating plates (14, 15).

5. Method in accordance with claim 1, wherein the suction (37) is applied immediately after the mold (21, 22) has been closed.

6. Method in accordance with claim 1, wherein the suction (37) is applied as a short surge.

7. Method in accordance with claim 1, wherein the suction (37) is applied in the form of several successive surges.

8. Method in accordance with claim 7, wherein the surges of suction vary with respect to their duration and/or suction maximum.

9. Method in accordance with claim 1, wherein the preliminary product (10) is placed in the hot mold; that the preliminary product (10) is then heated to the requisite operating temperature inside the closed mold; and that the mold is then opened, and the molded part (30) is removed and cooled outside the mold.

10. Method in accordance with claim 1, wherein, instead of the nonwoven being prebonded to form the preliminary product (10), the nonwoven, which contains bonding agents (11) that are still untreated, is placed between the heating plates (14, 15) or in the heatable mold, where it is then directly subjected to its heat treatment until the requisite operating temperature is reached.

11. Device for carrying out the method in accordance with claim 1, which comprises a press with at least two mold members (21, 22) that can be moved relative to each other, wherein, when the press is closed, the mold members (21, 22) enclose a cavity (24) between them, which is the negative of the desired profile (31) of the molded part (30), and this cavity (24) holds the preliminary product (10, 20), wherein a suction device (17) is assigned to the mold members (21, 22), and at least one suction line (18) leads from the suction device; that the suction lines (18) are connected at well-defined points (19) of at least one of the two mold members (21, 22); and that at least one suction channel (29) leads from the connection points (19) of the suction lines (18), penetrates the wall of the mold and opens on the inner contour (26, 25) of the cavity (24).

12. Device in accordance with claim 11, wherein a control unit (36) is assigned to the suction device (17), and that the time of initiation and the duration of action of the suction device 17 are determined by the control unit (36) as a function of the progress of the formation of the molded part in the cavity 24 of the mold (21, 22).

13. Device in accordance with claim 11, wherein the suction channels (29) are provided in only one mold member (22).

14. Device in accordance with claim 11, wherein the suction channels (29) are provided in both mold members (21, 22).
